(19) United States
(12) Patent Application Publication
(10) Pub. No.: US 2005/0269803 A1
(43) Pub. Date: Dec. 8, 2005

(54) Front wheel of a folding golf cart

(76) Inventor: Fang-Li Wu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/862,388

(22) Filed: Jun. 8, 2004

(51) Int. Cl. B62B 3/02

(52) U.S. Cl. 280/651

(57) ABSTRACT

A folding golf cart includes a frame, first and second fixed lateral bodies secured on a lower end of the frame, a pivotal rod connected with both of the lateral bodies at two ends, a locking lever pivoted to the second lateral body and movable to such a position as to engage the first lateral body, an angularly displaceable middle body arranged between the lateral bodies and pivoted on the pivotal rod, a front wheel, and a support of the front wheel, which is secured to the middle body; the locking lever will also engage the middle body when it engages the first lateral body after the front wheel is moved to either one of stretched position and folded position; the lateral bodies are formed with stopping blocks, which will stop the middle body as soon as the front wheel is moved to either of stretched position and folded position.

### BACKGROUND OF THE INVENTION

1. Field of the Invention

The present invention relates to a foldable front wheel of a golf cart, more particularly one, which can be securely held in stretched position for allowing the golf cart to move along smoothly, and can be easily unlocked and smoothly moved between the stretched position and the folded position without possibility of causing damage to those parts of the golf cart that are connected with it.

2. Brief Description of the Prior Art

Referring to FIG. 1, a conventional folding golf cart 1 includes a frame 11, a handle 12 pivoted to an upper end of the frame 11, two rear wheel supports 13 pivoted to a middle portion of the frame 11, rear wheels 14 respectively connected with the rear wheel supports 13, two connecting rods 15, a lower support 16 secured on the frame 11 for supporting a golf bag on, a pivotal mechanism 17 connected with the frame 11, a front wheel support 19, and a front wheel 18 fitted to the front wheel support 19.

The pivotal mechanism 17 includes a middle pivotal body 171, a pairs of lateral pivotal bodies 172, a bolt 174, and a knob 175; the lateral pivotal bodies 172 have engaging toothed sides 1722, and fitting holes 1721, and are respectively securely joined to lower ends of rod portions of the frame 11 with the lower ends of the frame 11 being passed into the fitting holes 1721, and with the engaging toothed sides 1722 facing each other; the bolt 174 is passed through both of the lateral pivotal bodies 172, and screwed into the knob 175 at a tail end; the middle pivotal body 171 has engaging toothed sides 1711 on two ends, and is arranged between the lateral pivotal bodies 172, and pivoted on the bolt 174 such that it is angularly displaceable relative to the frame 11, and such that the toothed sides 1711 facing respective ones of the toothed sides 1722.

The front wheel support 19 is securely joined to the middle pivotal body 171 to be movable together with the pivotal body 171. Therefore, when the knob 175 is screwed to a tight position, the lateral bodies 172 will be engaged with the middle pivotal body 171 at the toothed sides 1722, and in turns, the wheel support 19 can't move relative to the frame 11. And, when the knob 175 is screwed loose, the lateral bodies 172 will stop engaging the middle pivotal body 171, and in turns, the front wheel 18 can be changed in the orientation relative to the frame 11 together with the middle pivotal body 171. Thus, the front wheel 18 can be secured in a stretched position for use, and can be secured in a folded position when the golf cart 1 isn't used.

However, the pivotal mechanism 17 for the front wheel 18 is found to have disadvantages as followings:
1. Even though the knob 175 has been turned loose, the middle pivotal body 171 can be rubbed against the toothed sides 1722 at the toothed sides 1711 thereof while the front wheel 18 is being displaced relative to the frame 11. Consequently, the engaging toothed sides 1711 and 1722 will be damaged, and the front wheel 18 can't be secured in position any more.
2. The user can turn the knob 175 too much after changing the position of the front wheel 18, and in turns, screw threads of the knob 175 and the bolt 174 will get damaged.
3. The knob 175 can become loose owing to vibration of the golf cart, and in turns, the front wheel 18 will be away from the stretched position while the golf cart is being used.
4. It is difficult for the user to move the front wheel 18 to a same proper stretched position in every stretching action, and also difficult to move the front wheel 18 to a same folded position in every folding action because the golf cart isn't equipped with a mechanism that will stop the middle pivotal body 171 as soon as the front wheel 18 is moved to either of the proper positions.

### SUMMARY

It is a main object of the present invention to provide such a folding structure to a front wheel of a golf cart that the above disadvantages can be overcome.

The golf cart of the present invention includes a frame, first and second lateral bodies secured on a lower end of the frame, a pivotal rod connected with both of the lateral bodies at two ends, a locking lever pivoted to the second lateral body and movable to such a position as to engage the first lateral body, a middle body arranged between the lateral bodies and pivoted on the pivotal rod, a front wheel, and a support of the front wheel secured to the middle body. The locking lever will also engage the middle body effectively when it engages the first lateral body after the front wheel is moved to either one of the stretched position and the folded position. The lateral bodies are formed with stopping blocks, which will stop the middle body as soon as the front wheel is moved to either one of stretched position and folded position; thus, the front wheel can be moved to the same stretched position in every stretching action, and the same folded one in every folding action.

### BRIEF DESCRIPTION OF THE DRAWINGS

The present invention will be better understood by referring to the accompanying drawings, wherein:

FIG. 1 is a side view of the conventional golf cart,

FIG. 2 is a top view of the folding structure for the front wheel of the conventional golf cart,

FIG. 3 is front view of the folding structure for the front wheel of the conventional golf cart,

FIG. 4 is a side view of the golf cart of the present invention, with the front wheel in the stretched position,

FIG. 5 is an exploded perspective view of the folding mechanism according to the present invention,

FIG. 6 is another exploded perspective view of the folding mechanism according to the present invention,

FIG. 7 is a perspective view of the present folding mechanism,

FIG. 8 is a side view of the present folding mechanism,

FIG. 9 is a top view of the present folding mechanism,

FIG. 10 is a side view of the present folding mechanism, and

FIG. 11 is a side view of the golf cart of the present invention, with the front wheel in the folded position.

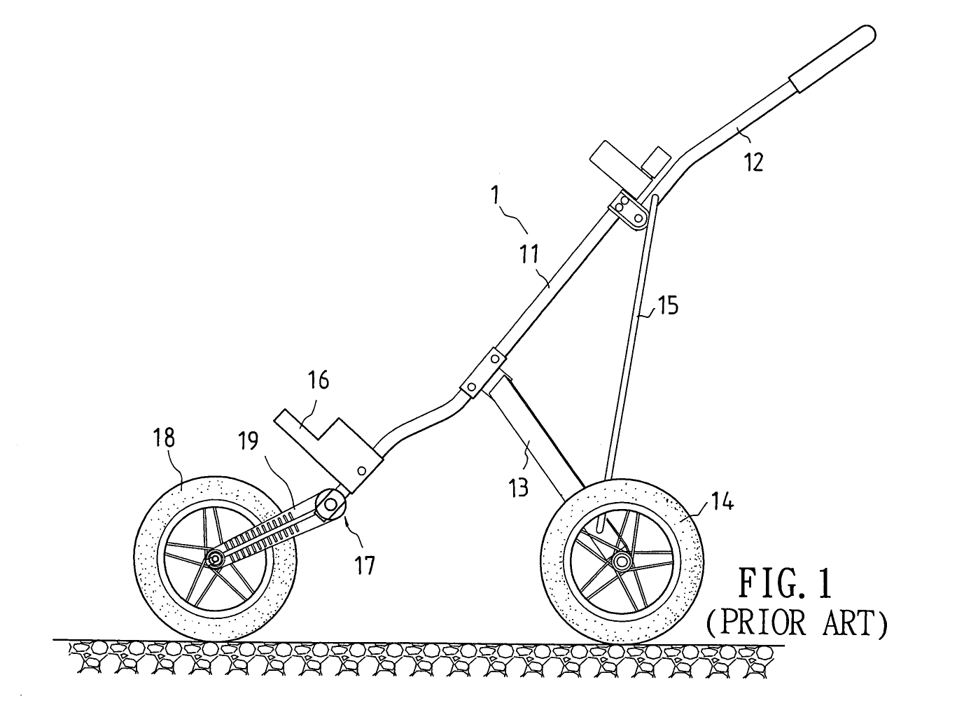

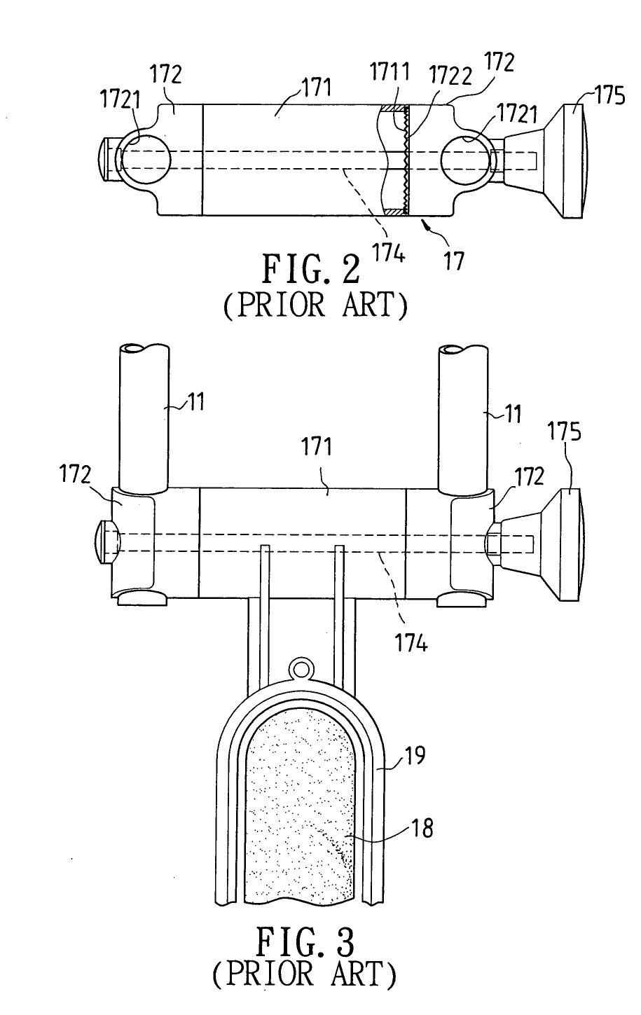

### DETAILED DESCRIPTION OF THE PREFERRED EMBODIMENTS

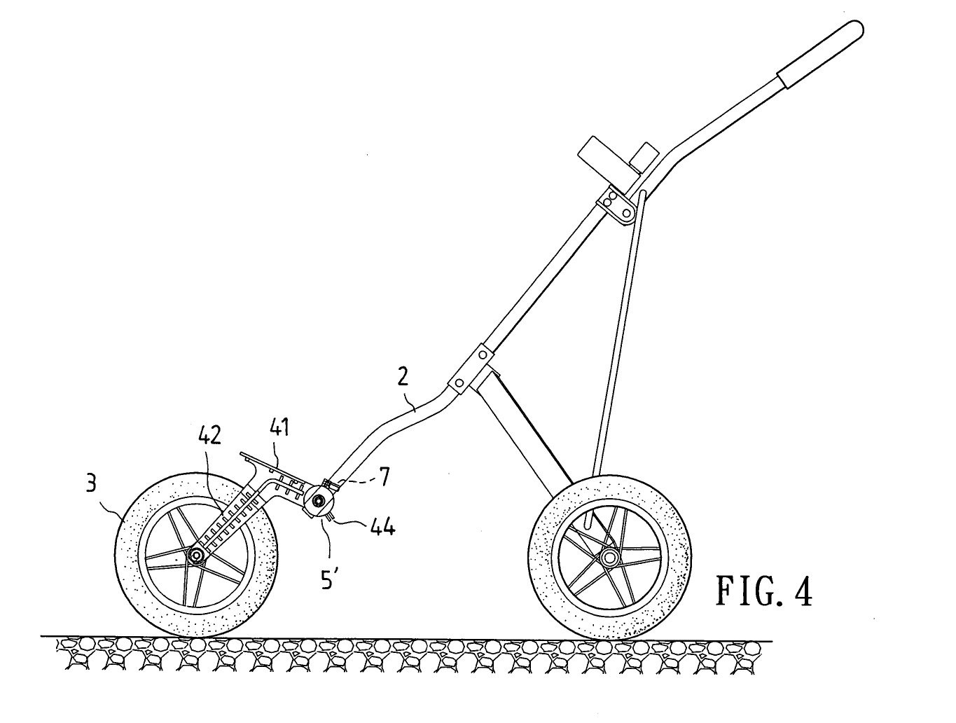

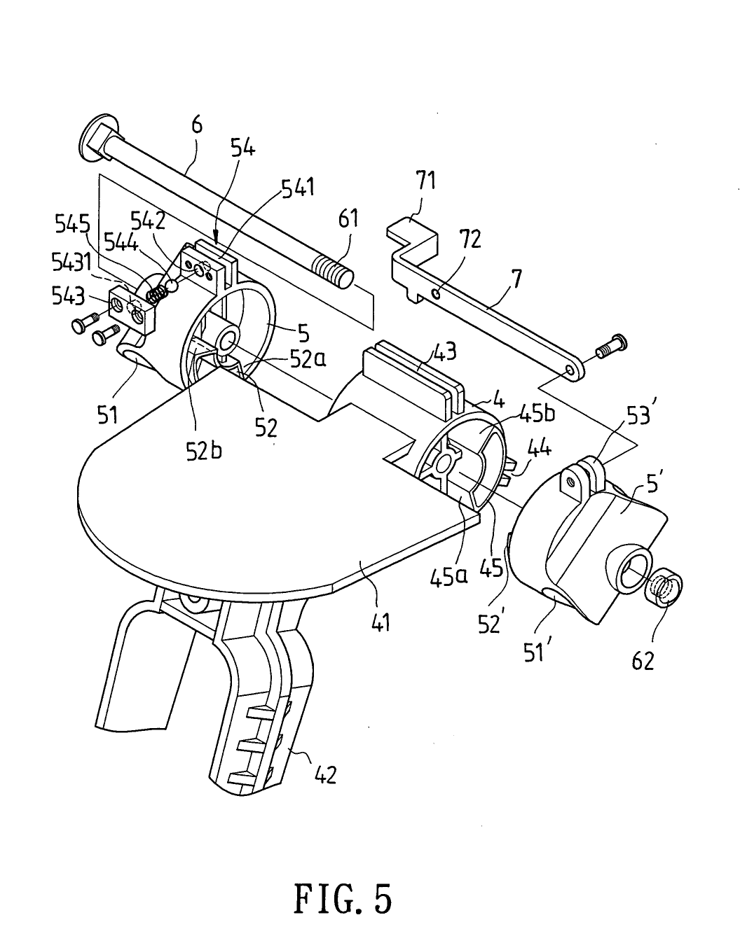

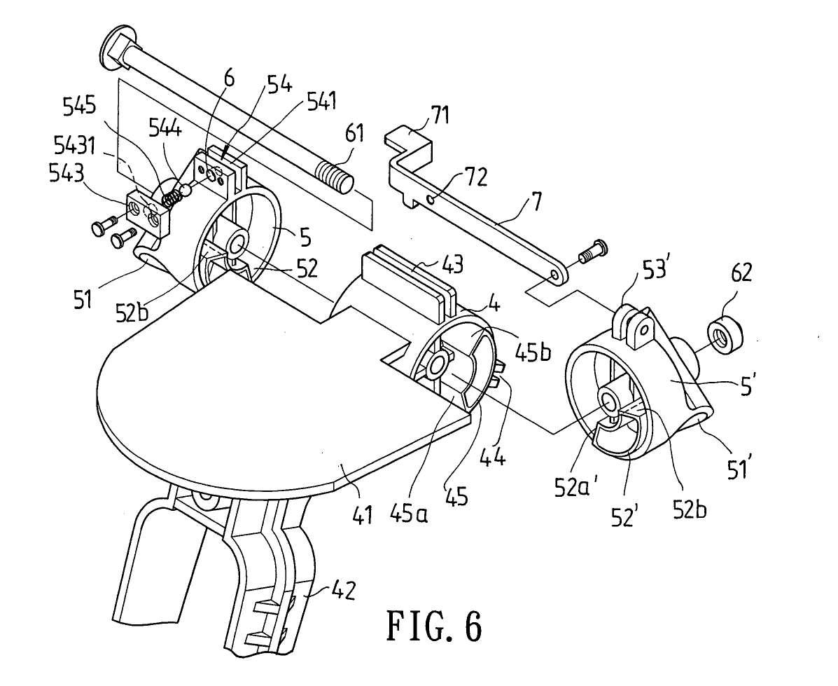

Referring to FIGS. 4 to 6, a preferred embodiment of a golf cart includes a frame 2, two lateral pivotal bodies 5, 5′, a middle pivotal body 4, a supporting member 41, a wheel support 42, and a front wheel 3.

The lateral pivotal bodies 5, 5′ have fitting holes 51, 51′ respectively, and are securely connected with respective ones of lower ends of two rod parts of the frame 2 at the fitting holes 51, 51′. The lateral pivotal body 5 has a holding portion, a stopping block 52 in the holding portion, and a locking portion 54 on an outer side of the holding portion; the holding portion has a central axial hole; the stopping block 52 projects beyond an inward end of the holding portion, and has a lower side 52a and an upper side 52b.

The lateral pivotal body 5′ has a holding portion, a stopping block 52′ in the holding portion, and a pivotal portion 53′ on an outer side of the holding portion; the holding portion has a central axial hole; the stopping block 52′ projects beyond an inward end of the holding portion, and has a lower side 52a′ and an upper side 52b′.

The pivotal rod 6 is passed through the central axial holes of the lateral pivotal bodies 5, 5′, and connected with a nut 62 at a threaded tail end 61 thereof so as to be secured in position.

The locking lever 7 is pivoted to the pivotal portion 53′ of the lateral pivotal body 5′ at a first end, and has a fingered portion 71 at a second end, and a locking hole 72.

The locking portion 54 of the lateral pivotal body 5 includes an engaging trench 541, which is defined by two spaced parallel wall portions, a locating plate 543, a locking bead 544, and an elastic element 545; a first one of the wall portions is formed with a through hole 542; the locating plate 543 is secured in position next to an outward side of the first wall portion, and has a locating cavity 5431 opposing the through hole 542; the elastic element 545 is fitted in the locating cavity 5431 of the locating plate 543 at a first end, and held in the through hole 542 at a second end.

The locking bead 544 is positioned next to the second end of the elastic element 545 such that it is normally biased to the trench 541 by the elastic element 545, and such that it will be forced to move out of the trench 541 and completely into the through hole 542 when the locking lever 7 is pressed against it; the locking bead 544 will be made to move into the locking hole 72 to engage the lever 7 as soon as the locking lever 7 is passed into the trench 541; the locking lever 7 will disengage the locking bead 544 as soon as the user begins to exert upward force on the fingered portion 71 in order to pivot the lever 7 away from the trench 541 of the locking portion 54 of the lateral block 5.

The supporting member 41 is securely joined to the middle pivotal body 4 while the wheel support 42 is securely joined to a lower side of the supporting member 41. And, the front wheel 3 is supported on the wheel support 42.

The middle pivotal body 4 has a cylindrical holding portion, and first and second engaging trenches 43, 44 on an outer side of the holding portion, which trenches 43, 44 are respectively defined by two spaced parallel wall portions. In addition, the cylindrical holding portion has a central axial hole. And, the pivotal body 4 has a stopping block 45 in the cylindrical holding portion, which has a lower side 45a and an upper side 45b.

The middle pivotal body 4 is arranged between the lateral pivotal bodies 5 and 5′ with the pivotal rod 6 being passed through the central axial hole thereof; thus, the stopping blocks 52 and 52′ of the lateral pivotal bodies 5 and 5′ project into the cylindrical holding portion of the middle pivotal body 4. Consequently, the middle pivotal body 4 can be angularly displaced relative to the frame 2.

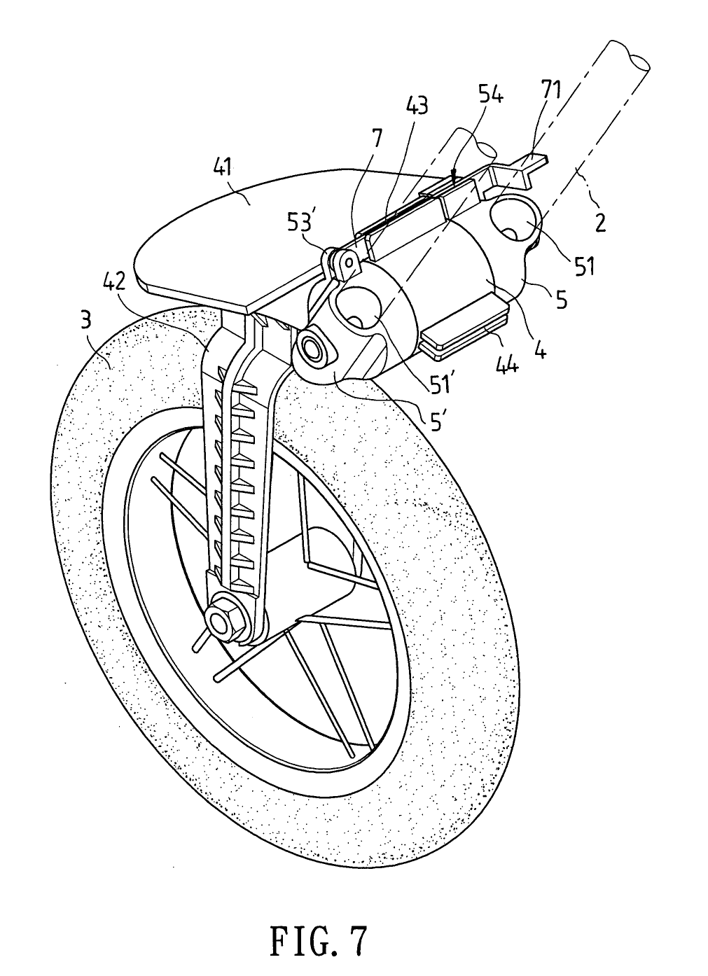

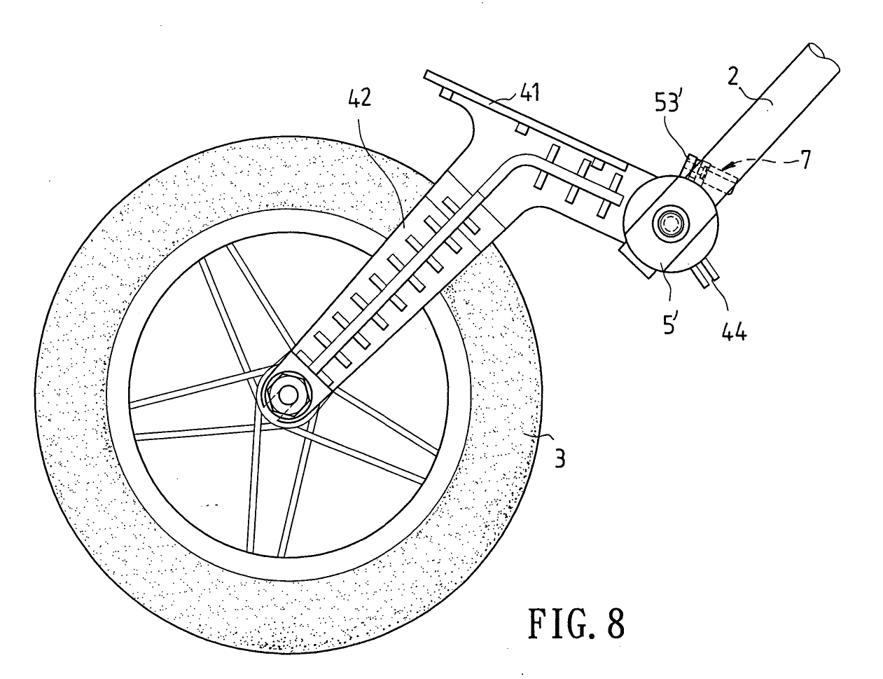

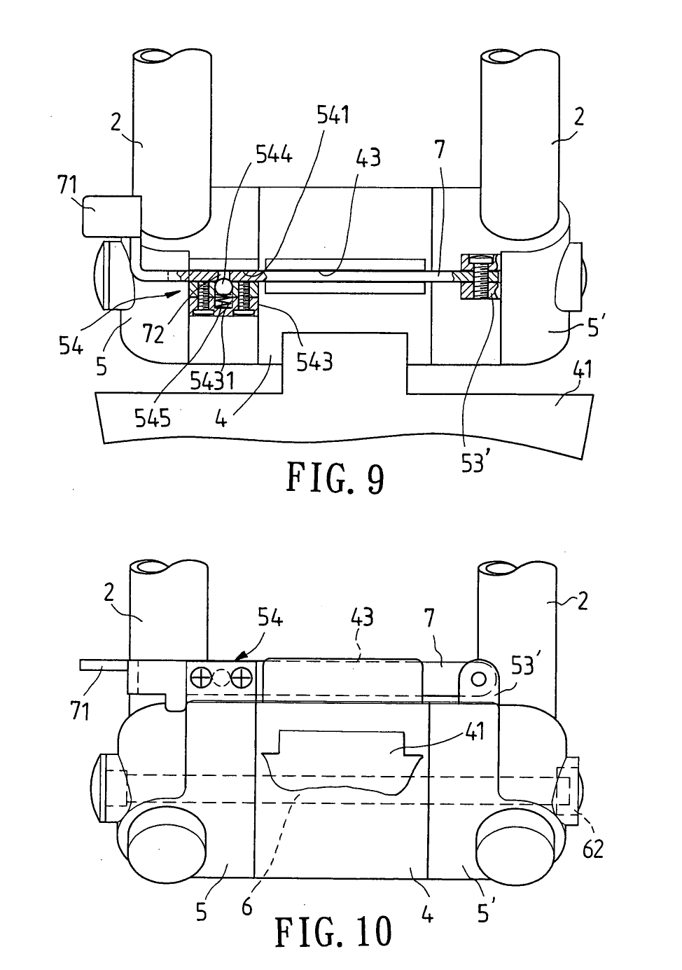

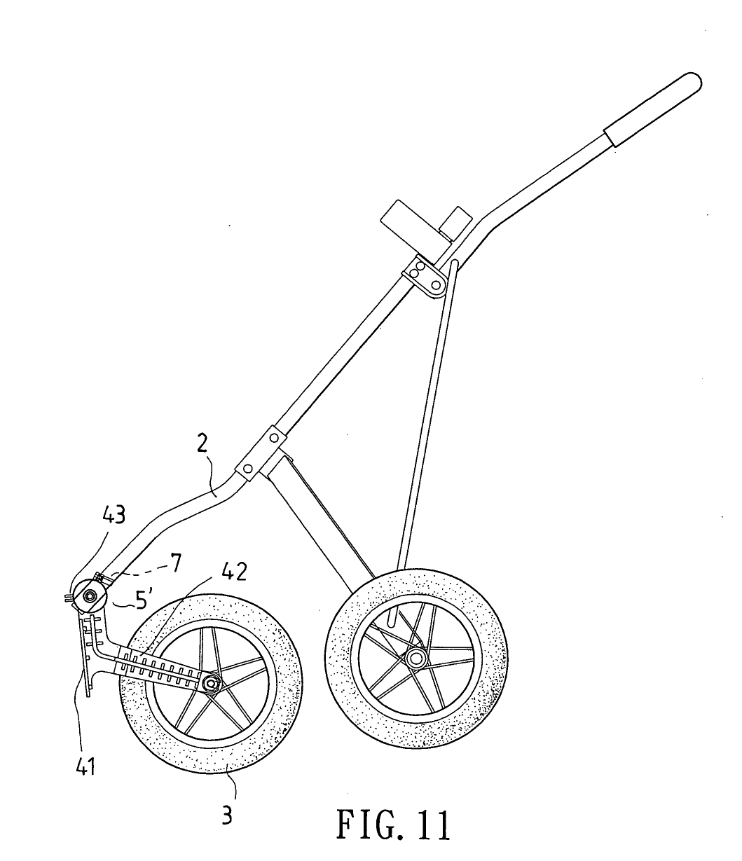

The first trench 43 of the middle pivotal body 4 will be aligned with the trench 541, and the lower side 45a of the stopping block 45 will come into contact with the lower sides 52a and 52a′ of the stopping blocks 52 and 52′ as soon as the wheel support 42 and the front wheel 3 are moved to the stretched position, as shown in FIG. 7. And, the second trench 44 will be aligned with the trench 541 of the lateral pivotal block 5, and the upper side 45b of the stopping block 45 will come into contact with the upper sides 52b and 52b′ of the stopping blocks 52 and 52′ as soon as the front wheel 3 is moved to the folded position together with the wheel support 42, as shown in FIG. 11.

To change position of the front wheel 3, the user first has to disengage the locking lever 7 from the bead 544, and pivot the locking lever 7 away from the lateral and the middle pivotal bodies 5 and 4. Next, to stretch the front wheel 3, the middle pivotal body 4 is turned until the lower side 45a of the stopping block 45 comes into contact with the lower sides 52a and 52a′ of the stopping blocks 52 and 52′ such that the trench 43 is aligned with the trench 541, and the front wheel 3 in the stretched position. Or, to fold the front wheel 3, the middle pivotal body 4 is turned until the upper side 45b of the stopping block 45 comes into contact with the upper sides 52b and 52b′ of the stopping blocks 52 and 52′ such that the trench 44 is aligned with the trench 541, and the front wheel 3 in the folded position. Thus, the wheel support 42 will be secured in position together with the middle pivotal body 4 as soon as the locking lever 7 is fitted into the trench 43 (44) of the middle body 4 as well as the trench 541 of the lateral body 5.

From the above description, it can be easily understood that the folding structure of a front wheel of a golf cart of the present invention has advantages as followings:
1. The support 42 for the front wheel can be securely held in position owing to the engagement between the locking lever 7 and the trenches 541 and 43 (44). The middle pivotal block 4 can be unlocked for allowing change of position of the front wheel by means of pivoting the locking lever 7 upwards and away from the trenches 541 and 43 (44). Therefore, the front wheel is easy and convenient to use. And, the front wheel can be smoothly moved between the folded position and the stretched one without unnecessary obstacles.
2. The front wheel can be rapidly and exactly moved to the folded position and the stretched position because of the stopping blocks 52, 52′ of the lateral pivotal bodies 5 and 5′ and the stopping block 45 of the middle pivotal body 4.
3. Because of the locking bead 542 and the locking hole 72 of the locking lever 7, the locking lever 7 can engage the locking portion 54 of the pivotal body 5 effectively.
4. Because of the above reason, the locking lever 7 can't separate from the pivotal body 5 accidentally when the golf cart is moving along.

1. A folding golf cart, comprising
a frame;
separate and opposing first and second lateral pivotal bodies secured on a lower end of the frame; the first pivotal body having a locking portion thereon; the second pivotal body having a pivotal portion corresponding to the locking portion of the first pivotal body;
a pivotal rod passed through the first and the second lateral pivotal bodies and connected with a nut at a threaded tail end thereof;
a locking lever pivoted to the pivotal portion of the second pivotal body at a first end thereof; the locking lever being movable to a first position where it engages the locking portion of the first lateral pivotal body, and movable to a second position where it disengages the locking portion; the locking lever having a fingered portion at a second end thereof for exerting force on;
a middle pivotal body arranged between the lateral pivotal bodies and pivoted on the pivotal rod so as to be angularly displaceable relative to the frame; the middle pivotal body having first and second engaging trenches on an outer side thereof for allowing the locking lever to be passed into;
a supporting member securely joined to the middle pivotal body;
a wheel support securely joined to a lower side of the supporting member; and
a front wheel supported on the wheel support so as to be angularly displaced relative to the frame together with the middle pivotal body between a stretched position and a folded position;
the first engaging trench of the middle pivotal body being aligned with the locking portion of the first lateral pivotal body when the front wheel is in the stretched position;
the second engaging trench of the middle pivotal body being aligned with the locking portion of the first lateral pivotal body when the front wheel is in the folded position;
whereby the locking lever will be held in the first engaging trench, and engaged with the locking portion of the first lateral pivotal body to prevent the middle pivotal body from moving relative to the lateral pivotal bodies as soon as it is moved to the first position thereof after the front wheel has been moved to the stretched position, thus securing the front wheel in the stretched position; and
whereby the locking lever will be held in the second engaging trench, and engaged with the locking portion to prevent the middle pivotal body from moving relative to the lateral pivotal bodies as soon as it is moved to the first position thereof after the front wheel has been moved to the folded position, thus securing the front wheel in the folded position.

2. The folding golf cart as claimed in claim 1, wherein the middle pivotal body is formed with a stopping block, and each of the lateral pivotal bodies is formed with a stopping block projecting into the middle pivotal body; the stopping block of the middle pivotal body being going to come into contact with the stopping blocks of the lateral pivotal bodies as soon as the front wheel is moved to the stretched position and as soon as the front wheel is moved to the folded position.

3. The folding golf cart as claimed in claim 1, wherein the locking lever has a locking hole near to the second end thereof, and the locking portion of the first lateral pivotal body includes:
(1) separate and opposing first and second wall portions, which define a third trench between them; the first wall portion is formed with a through hole;
(2) a locating plate secured next to an outward side of the first wall portion; the locating plate having a locating cavity opposing the through hole of the first wall portion;
(3) an elastic element fitted in the locating cavity at a first end, and held in the through hole of the first wall portion at a second end; and
(4) a locking bead positioned next to the second end of the elastic element so as to be normally biased to the third trench of the locking portion by the elastic element;
the locking bead being going to be forced to move out of the third trench and completely into the through hole by the locking lever as soon as the locking lever is pressed against it; the locking bead being capable of being made to move into the locking hole by the elastic element when the locking lever is held in the third trench, thus engaging the locking lever.
